(19) United States
(12) Patent Application Publication
(10) Pub. No.: US 2026/0156393 A1
(43) Pub. Date: Jun. 4, 2026

(54) SYSTEM AND METHOD FOR A WIRELESS REMOTE SPEAKER MICROPHONE TO ENTER INACTIVE OPERATIONAL STATE UPON DETECTION OF A FORCED DISPLACEMENT

(71) Applicant: MOTOROLA SOLUTIONS, INC., CHICAGO, IL (US)

(72) Inventors: ELLIS A PINDER, DAVIE, FL (US); DANIEL GROBE SACHS, ELMHURST, FL (US)

(21) Appl. No.: 18/967,902

(22) Filed: Dec. 4, 2024

(51) Int. Cl. H04R 1/02; G08B 21/18; H04R 1/04

(52) U.S. Cl. CPC H04R 1/028; G08B 21/182; H04R 1/04; H04R 2420/07

(57) ABSTRACT

Techniques for a wireless remote speaker microphone entering an inactive operational state upon detection of a forced displacement are provided. A wireless remote speaker microphone paired with a portable radio periodically samples input from an inertial measurement unit coupled to the wireless remote speaker microphone, to detect motion of the wireless speaker microphone. It is determined that the motion of the wireless remote speaker microphone is a forced displacement motion. The wireless remote speaker microphone enters an inactive operational state.

### BACKGROUND

In the public safety field, first responders (e.g. police, fire, emergency medical services, etc.) are often equipped with mission critical communications equipment that are generically referred to as Land Mobile Radio (LMR) systems. Some examples of such systems include the Project 25 LMR system generally used in North America and the TETRA system generally used outside of North America. One common form factor for such radios is a portable form factor (e.g. walkie talkie). A portable radio allows for wireless two way communications between first responders, dispatchers, etc.

A portable radio, in addition to the radio frequency (RF) components that enable wireless communication, may include a speaker through which communications are output and a microphone to capture the speech of the user when transmitting. In addition, the portable radio may include a Push-to-Talk (PTT) button. When the user wishes to transmit, they press the PTT button, in some cases wait for a talk permit tone, and then begin speaking. The audio is broadcast to other first responders.

The portable radio is typically carried on a belt around the waist of the first responder. Using the portable radio may require the user to remove the portable radio from their belt and bring it near their mouth when wishing to communicate. In addition, because the speaker of the portable radio is on the belt and is somewhat distant from the user's ear, the volume level of the portable radio must be set to be sufficiently high in order to ensure the first responder can hear any incoming communications. This has the downside that others around the first responder may also hear the communication, which may contain information that should not be shared with the general public.

To alleviate these concerns, devices known as Remote Speaker Microphones (RSM) have been created. The RSM includes a speaker, microphone, and PTT button and is coupled to the portable radio with a cable. Typically, the portable radio will be worn on the belt of the first responder and the RSM will be attached near the lapel of the first responder's uniform. Because the speaker of the RSM is closer to the responder's ear, the volume need not be set to a high level. In addition, when the officer wishes to speak, they can simply use the PTT button on the RSM and speak into the microphone of the RSM. There is no longer a need for the responder to remove the portable radio from their belt, thus providing a convenient way to use their radio.

Although the RSM solves many usability concerns of the portable radio, the RSM itself may be uncomfortable for a first responder to wear. In particular, the cable connecting the RSM to the portable wraps around the responder's body and may cause discomfort to the user. To alleviate this problem, wireless RSMs have been created that provide the same functionality as cabled RSM, minus the cable. The wireless RSM can connect to the portable radio with any known or later developed wireless technology. For example, many wireless RSMs are coupled to the portable radio via Bluetooth™. Any other wireless connection protocol may also be used.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 depicts a scenario in which the techniques described herein may be implemented.

FIG. 2 depicts an example flow diagram of an implementation of the techniques described herein.

FIG. 3 depicts an example of sources of data that may be used to create a training data set, which can be used to train a machine learning model to detect a forced displacement.

FIG. 4 is an example of a hardware device that may implement a wireless RSM.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Although the introduction of wireless RSMs has resolved many of the downsides of the regular wired RSMs, this has not come without additional disadvantages. The main disadvantage is that the cord of a wired RSM served as a secondary retention means. Due to the nature of the work of first responders, in particular police officers, they may from time to time get involved in physical altercations. For example, a police officer may have to physically struggle with a suspect who is resisting arrest. During such physical altercations, a RSM may become physically separated from the responder's body. In the case of a wired RSM, this is not a major issue, as the cord connecting the wired RSM to the portable radio remains attached. Because the portable radio is generally more firmly attached to the responder's belt, this effectively means the wired RSM will remain physically tethered to the responder.

The same cannot be said with a wireless RSM. If a wireless RSM becomes displaced from the responder's body, there is nothing tethering it to the responder's body. Thus, the wireless RSM may fall to the ground, into surrounding vegetation, etc. If the wireless RSM is displaced while the responder is on the move (e.g. chasing a suspect, etc.), it may fall to the ground and remain there until the responder returns to retrieve the device. If the responder does not remember exactly where the displacement occurred (e.g. a chase is a high stress situation, etc.) they would need to search the path they traversed looking for the wireless RSM. This could be made more difficult depending on the terrain where the device was displaced. For example, the wireless RSM may have been displaced and fallen into thick vegetation making finding the device more difficult.

Although becoming physically separated from the wireless RSM when a displacement occurs, that is far from the only problem. As mentioned above, the audio from the portable radio is routed to the speaker of the wireless RSM. This does not stop because the wireless RSM has been displaced. Thus, until the responder manually re-routes audio back to the portable radio, they will not hear any incoming communications. Similarly, as the PTT button on the wireless RSM is no longer available, when the responder wishes to communicate, they will need to use the PTT button on the portable radio. The PTT button on the portable radio will generally use the microphone built into the portable radio, thus requiring removing the portable radio from the responder's belt.

Another concern is that the wireless RSM may be used maliciously by someone finding the displaced device. Wireless RSMs may have very long ranges. Some models can stay connected to the portable radio well beyond 50 meters. A bad actor may find a displaced RSM that is still connected to the portable radio. At minimum, the bad actor would be able to hear communications intended for the responder. The bad actor may utilize the PTT button on the wireless RSM and disrupt all responder's communications. Typically, the communications networks used by first responders are half duplex, meaning the communications channel can only be used by one transmitter at a time. Thus, the bad actor could press the PTT button and occupy the communications channel, thus preventing any other first responders from using the communications channel.

The techniques described herein resolve these problems, individually and collective. First, using various techniques described below, it is determined that a forced displacement has occurred. The techniques allow for distinguishing a forced displacement from other types of motion. For example, a responder dropping his wireless RSM on the table at the end of a shift should not be classified as a forced displacement. A responder falling to the ground with the wireless RSM remaining attached should also not be categorized as a forced displacement.

Once it has been determined that the wireless RSM has experienced a forced displacement, the wireless RSM goes into what will be referred to as an inactive operational state. In the inactive operational state, the wireless RSM causes audio communication to be re-routed to the speaker on the portable radio. Someone finding the wireless RSM will not be able to hear the audio communications and the responder will be able to hear the communications via the portable radio. In addition, the PTT button and the microphone on the wireless RSM will be disabled. As such, anyone who finds the wireless RSM will not be able to interfere with communications by activating the wireless RSM PTT button and/or speaking into the microphone of the wireless RSM.

In addition to causing the audio to be routed to the speaker of the portable radio, the portable radio may also be instructed to play an audible alert to notify the responder that their wireless RSM has been forced displaced. In a high stress situation such as a chase, the responder may not have even noticed the wireless RSM is no longer attached to their body. The wireless RSM may also provide assistance in locating the forced displaced device. For example, the wireless RSM may play an audible alert to help in locating the device. The wireless RSM may also turn on/flash a light on the device to aid in locating the device. In additional, the wireless RSM may at some point delete bonding information between the wireless RSM and the portable radio.

Once the wireless RSM has been recovered, it may exit the inactive operational state. Exiting the inactive operational state includes re-routing the audio from the portable radio speaker back to the wireless RSM as well as re-enabling the microphone and PTT button. Any location features (e.g. audible sound, light, etc.) used for aiding in locating the wireless RSM can be turned off. Exiting the inactive operation state can occur in many different ways. For example, the wireless RSM may be re-bonded with the portable radio if the bonding information had been deleted. The wireless RSM could be re-paired with the portable radio if the bonding information was not deleted. In some cases, the repairing could be performed using touch re-pairing, which would confirm the portable radio and wireless RSM are once again in close proximity to each other. Exiting the inactive operational state could include a menu item on the portable radio or a specific PTT key sequence on the wireless RSM.

A method is provided. The method includes periodically sampling, by a wireless remote speaker microphone paired with a portable radio, input from an inertial measurement unit coupled to the wireless remote speaker microphone, to detect motion of the wireless remote speaker microphone. The method also incudes determining that the motion of the wireless remote speaker microphone is a forced displacement motion. The method also includes entering, by the wireless remote speaker microphone, an inactive operational state.

In one aspect, entering the inactive operational state further comprises instructing the portable radio to discontinue routing audio to the wireless remote speaker microphone and disabling a Push-to-Talk button on the wireless remote speaker microphone. In one aspect, entering the inactive operational state further comprises generating, by the wireless remote speaker microphone, at least one of an audible locator alert and a visual locator alert. In one aspect, the method further comprises exiting, by the wireless remote speaker microphone, the inactive operational state when the wireless remote speaker microphone is re-paired with the portable radio.

In one aspect, determining that the motion of the wireless remote speaker microphone is a forced displacement motion further comprises determining, with a trained Artificial Intelligence model, that the input from the inertial measurement unit is consistent with a forced displacement event, the Artificial Intelligence model having been trained with measurements from confirmed forced displacement events. In one aspect, the measurements from confirmed forced displacements further include measurement from an inertial measurement unit coupled to the portable radio. In one aspect, entering, by the wireless remote speaker microphone, the inactive operational state further comprises deleting a bonding information between the wireless remote speaker microphone and the portable radio.

A system is provided. The system includes a processor and a memory coupled to the processor. The memory contains a set of instructions thereon that when executed by the processor cause the processor to periodically sample, by a wireless remote speaker microphone paired with a portable radio, input from an inertial measurement unit coupled to the wireless remote speaker microphone, to detect motion of the wireless remote speaker microphone. The instructions on the memory also cause the processor to determine that the motion of the wireless remote speaker microphone is a forced displacement motion. The instructions on the memory also cause the processor to enter, by the wireless remote speaker microphone, an inactive operational state.

In one aspect, entering the inactive operational state further comprises instructions on the memory to instruct the portable radio to discontinue routing audio to the wireless remote speaker microphone and disable a Push-to-Talk button on the wireless remote speaker microphone. In one aspect, entering the inactive operational state further comprises instructions on the memory to generate, by the wireless remote speaker microphone, at least one of an audible locator alert and a visual locator alert. In one aspect, the instructions on the memory cause the processor to exit, by the wireless remote speaker microphone, the inactive operational state when the wireless remote speaker microphone is re-paired with the portable radio.

In one aspect, determining that the motion of the wireless remote speaker microphone is a forced displacement motion further comprises instructions on the memory to determine, with a trained Artificial Intelligence model, that the input from the inertial measurement unit is consistent with a forced displacement event, the Artificial Intelligence model having been trained with measurements from confirmed forced displacement events. In one aspect, the measurements from confirmed forced displacements further include measurement from an inertial measurement unit coupled to the portable radio. In one aspect, entering, by the wireless remote speaker microphone, the inactive operational state further comprises instructions on the memory to delete a bonding information between the wireless remote speaker microphone and the portable radio.

A non-transitory processor readable medium containing a set of instructions thereon is provided. The instructions, that when executed by a processor, cause the processor to periodically sample, by a wireless remote speaker microphone paired with a portable radio, input from an inertial measurement unit coupled to the wireless remote speaker microphone, to detect motion of the wireless remote speaker microphone. The instructions on the medium also cause the processor to determine that the motion of the wireless remote speaker microphone is a forced displacement motion. The instructions on the medium also cause the processor to enter, by the wireless remote speaker microphone, an inactive operational state.

In one aspect, entering the inactive operational state further comprises instructions on the medium to instruct the portable radio to discontinue routing audio to the wireless remote speaker microphone and disable a Push-to-Talk button on the wireless remote speaker microphone. In one aspect, entering the inactive operational state further comprises instructions on the medium to generate, by the wireless remote speaker microphone, at least one of an audible locator alert and a visual locator alert. In one aspect, the instructions on the medium further cause the processor to exit, by the wireless remote speaker microphone, the inactive operational state when the wireless remote speaker microphone is re-paired with the portable radio.

In one aspect, determining that the motion of the wireless remote speaker microphone is a forced displacement motion further comprises instructions on the medium to determine, with a trained Artificial Intelligence model, that the input from the inertial measurement unit is consistent with a forced displacement event, the Artificial Intelligence model having been trained with measurements from confirmed forced displacement events. In one aspect, entering, by the wireless remote speaker microphone, the inactive operational state further comprises instructions on the medium to delete a bonding information between the wireless remote speaker microphone and the portable radio.

Further advantages and features consistent with this disclosure will be set forth in the following detailed description, with reference to the figures.

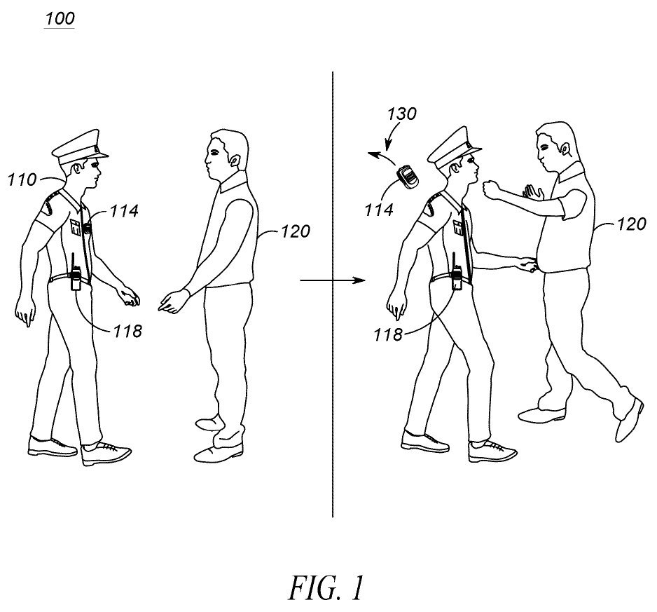

FIG. 1 depicts a scenario 100 in which the techniques described herein may be implemented. Depicted on the left in FIG. 1 is a first responder 110, shown as a police officer. Although the techniques described herein are applicable to any first responder, or in fact to any person equipped with a wireless RSM, it is most likely that a police officer will engage in physical altercations during which a wireless RSM may experience forced displacement. For ease of description, the remainder of the disclosure will refer to the person wearing a wireless RSM as an officer or police officer. However, it should be understood that this is for ease of description and is not intended to limit the techniques described herein to police officers.

The officer 110 is equipped with a wireless RSM 114. The wireless RSM allows for wireless communication with a portable radio 118. As described above, the wireless RSM includes a speaker, through which audio from the portable radio may be heard. The speaker may also be used to emit an alert when the wireless RSM has experienced a forced displacement. The wireless RSM also includes a PTT button to initiate communications as well as a microphone to capture the speech of the officer when the officer has pressed the PTT button. The wireless RSM may also include visual indicators, such as light emitting diodes, which may be used to aid in finding the wireless RSM if it becomes forcibly displaced.

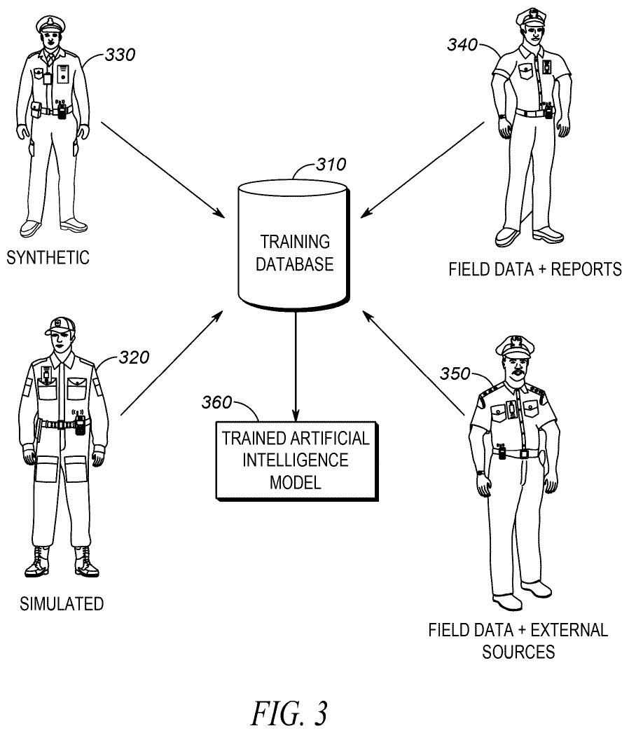

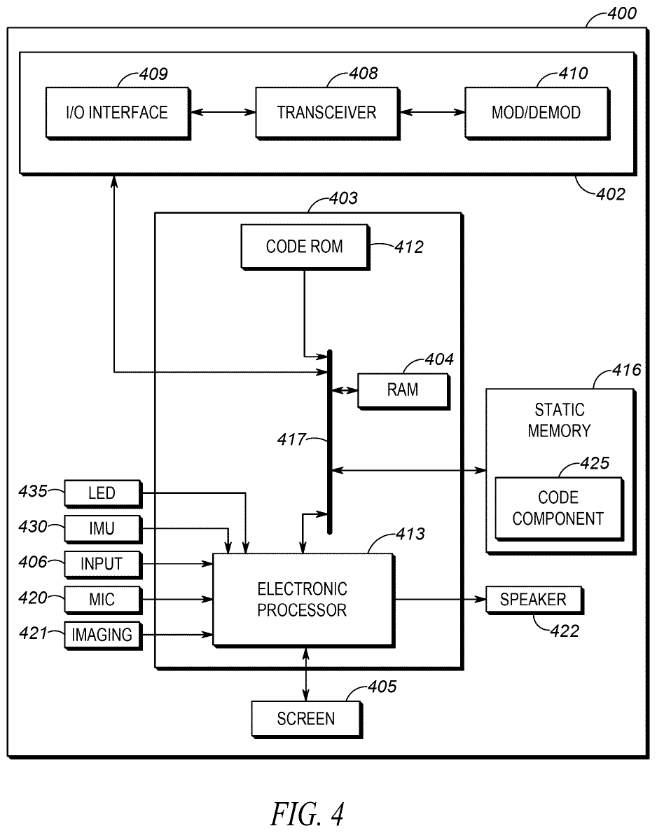

The wireless RSM 114 also includes an inertial measurement unit (IMU). The IMU typically includes a 3 axis gyroscope and 3 axis accelerometer. Some IMU's may also include a 3 axis compass. Regardless of the specific configuration, the IMU is able to measure the motion of the wireless RSM to detect forced displacement events. Detection of forced displacement events will be described in further detail with respect to FIG. 3. Until then, assume that the wireless RSM is able to distinguish a forced displacement (e.g. when the wireless RSM has become separated from the officer, etc.) and other motion (e.g. the officer has fallen, but the wireless RSM has not been separated). An example of a device that may implement the wireless RSM is described with respect to FIG. 4.

The officer 110 is carrying a portable radio 118. The portable radio may be used to communicate with other first responders, dispatchers, etc. through conventional communications networks, such as P25 and TETRA networks (not shown). The techniques described herein are applicable regardless of the type of communications system that is being used to allow communications between the first responders. The portable radio may also include an inertial measurement unit (IMU), similar to the one described with respect to the wireless RSM 114. The portable radio may be in wireless communication with the wireless RSM using known wireless communications techniques (e.g. Bluetooth, etc.). An example of a device that may implement the portable radio is described with respect to FIG. 4.

On the left side of FIG. 1 is also a person 120. For purposes of this example, the person may be a suspect in some type of crime, and will also be referred to as the suspect. Initially, the officer 110 may engage in a conversation with the suspect. At some point during the conversation, as shown on the right side of FIG. 1, the officer and the suspect may engage in a physical confrontation. For example, the officer may wish to detain and/or arrest the suspect and the suspect resists. During the confrontation, the wireless RSM 114 may become forcibly displaced 130.

Although the forcible displacement is described in terms of a physical confrontation, the forcible displacement can occur in other situations as well. For example, an officer 110 may engage in a foot pursuit with a suspect and the action of running may cause the wireless RSM 114 to become forcibly displaced. Regardless of why the forcible displacement of the wireless RSM has occurred, it should be understood that the forced displacement of the wireless RSM is detected by the wireless RSM.

As mentioned above, the detection of the forced displacement of the wireless RSM 114 will be described with respect to FIG. 3. For now, just assume that the forced displacement of the wireless RSM has occurred. Once the forced displacement has occurred, the wireless RSM will enter an inactive operational state. One of the first things that the wireless RSM will do in the inactive operational state is cause audio from the portable radio to be re-routed from the speaker of the wireless RSM to the speaker of the portable radio. By doing so, the officer 110 is able to hear communications from the portable radio. In addition, anyone who finds the wireless RSM will not be able to hear the communications.

In some implementations, the wireless RSM 114 may send an explicit instruction to the portable radio 118 to re-route the audio from the wireless RSM speaker to the portable radio speaker. In other implementations, the wireless RSM may simply send an indication to the portable radio that the wireless RSM has experienced a forced displacement and that the audio should be rerouted accordingly. Regardless of implementation, what should be understood is that during a forced displacement, the audio that had previously been routed to the speaker of the wireless RSM is now routed to the speaker of the portable radio. It should also be understood that because the wireless RSM is wireless, it can still communicate with the portable radio, even when it has experienced a forced displacement.

In addition to rerouting the audio, the wireless RSM 114 may also disable the PTT button on the wireless RSM when entering the inactive operational state. By disabling the PTT button on the wireless RSM, it can be assured that no one finding the wireless RSM would be able to press the PTT button on the wireless RSM and disrupt the communications of other first responders on the communications channel. In some implementations, the microphone on the wireless RSM may also be disabled.

When entering the inactive operational state, the wireless RSM 114 may also activate certain features that aid in finding the wireless RSM. As explained above, when the forced displacement occurs, the wireless RSM could end up anywhere (e.g. in thick vegetation, etc.) making it difficult to find. Furthermore, an officer 110 engaging in a foot chase, or some other similar activity, may not have even noticed the forced displacement of the wireless RSM.

One feature that may be activated when there is a forced displacement of the wireless RSM 114 is that an audible alert may be output from the portable radio 118 to indicate that a forced displacement has occurred. For example, the portable radio may output a tone or voice announcement out of the speaker of the portable radio. Because the portable radio is still attached to the officer 110, the officer can hear the audible indication. In many cases, the forced displacement may occur during a high stress situation (e.g. physical altercation, chase, etc.) and the officer 110 might not have even realized that his wireless RSM is no longer attached to his body. The audible indication may notify the officer that they need to start looking for and retrieve their wireless RSM.

To aid in the process of locating the wireless RSM 114, the wireless RSM itself may be outputting an audible tone. For example, an audible tone may be output through the speaker of the wireless RSM. Thus, the officer 110 searching for the wireless RSM can be assisted in locating the wireless RSM. Such a feature can be useful in the case where the forced displacement caused the wireless RSM to end up somewhere that is not easily seen. For example, if the wireless RSM falls into thick vegetation (e.g. weeds, etc.) it might be difficult to see. Other examples can include falling into trash on the street, falling underneath or behind another object (e.g. falling underneath a dumpster, etc.) that makes the wireless RSM no longer easily visible.

In some implementations, the wireless RSM 114 may not output the audible tone immediately, but may first initiate a countdown timer. Upon expiration of the countdown timer, the audible tone may begin. The reason for this is that in some cases, there may be some distance from where the officer 110 currently is and where the wireless RSM was forcibly displaced. For example, if the forced displacement occurred while the officer was chasing a suspect. In such cases, immediately outputting the audible tone may attract the attention of a bad actor who then takes the wireless RSM. By providing a delay before outputting the tone, the officer is given some time to return to the location where the forced displacement occurred. In addition, providing for a delay may provide some time for the officer to cancel the audible tone from the portable radio (e.g. the officer has found the wireless RSM and does not need the audible assistance, etc.).

Yet another feature that may be activated when there is a forced displacement of the wireless RSM 114 is the activation of a visual indicator on the wireless RSM to aid in locating the wireless RSM. For example, the wireless RSM may be equipped with one or more Light Emitting Diodes (LED) that can be activated (e.g. turned on, start flashing, etc.) to provide a visual indication of where the wireless RSM is currently located. The use of a visual indication may be especially useful at night when it would be much more difficult to find the wireless RSM that has experienced a forced displacement. Just as with the audible alert, and for similar reasons, the wireless RSM may initially set a countdown timer and not activate the visual alerting mechanisms until that countdown timer has expired.

In the preceding example description, the audible or visual aids in locating the wireless RSM 114 were started either upon the entrance to the inactive operational state or upon expiration of a timer after entering the inactive operational state. In another example implementation, the audible and visual location aids may not be activated until the officer 110 provides a command to the portable radio 118 to instruct the wireless RSM to activate those features. By requiring a command from the officer, the wireless RSM will not activate the location features unless instructed. This means that the officer can delay providing the command until the officer is actually looking for the wireless RSM, thus reducing the possibility that a bad actor locates and retrieves the wireless RSM prior to the officer finding it.

There are different modes of operation the wireless RSM 114 enters the inactive operational state. In one mode of operation, when the inactive operational state is entered, the wireless connection (e.g. Bluetooth, etc.) between the wireless RSM and the portable radio 118 is disconnected. In such implementations, decisions on deactivating the PTT button on the wireless RSM is left up to the wireless RSM itself. The portable radio 118, in response to the connection to the wireless RSM being severed may autonomously reroute audio to the speaker of the portable radio. The decision as to when to activate the audible and visual aids are left to the wireless RSM itself, as it is no longer in communication with the portable radio, and can thus no longer receive commands from the portable radio. In other implementations, the wireless connection between the wireless RSM and the portable radio is maintained, but the audio routing and functionality of the PTT button are modified as discussed above.

In some implementations, the wireless RSM 114, upon detection of a forced displacement, may start a “delete bonding” timer. Upon expiration of the timer, the wireless RSM may delete bonding information between the wireless RSM and the portable radio 118 such that the wireless RSM no longer has any information about the portable radio and as such will no longer automatically pair with the portable radio. The bonding information may be deleted immediately upon expiration of the timer or may not occur until the next time the wireless RSM is power cycled.

At some point the officer 110 may recover (e.g. pick up, etc.) the wireless RSM 114 that has experienced a forced displacement. At this point the officer may want to exit the inactive operational state and return to normal operation of the wireless RSM. This can be achieved through several different mechanisms, and the techniques described herein are not dependent on any particular technique. In one implementation, the wireless RSM and the portable radio 118 may first be re-bonded and then re-paired. Such bonding/re-pairing may occur using a user interface on the portable radio. In another implementation, the wireless RSM and portable radio may be bonded and re-paired using a touch pairing interface wherein the devices are brought within close proximity to one another and the bonding/pairing process automatically occurs. In some cases, if the wireless RSM and portable radio remain connected during the forced displacement, a command can be entered on a menu of the portable radio that causes an instruction to be sent to the wireless RSM to resume normal operation. In some implementations, the user may simply request redirection of the audio back to the wireless RSM via the portable radio user interface.

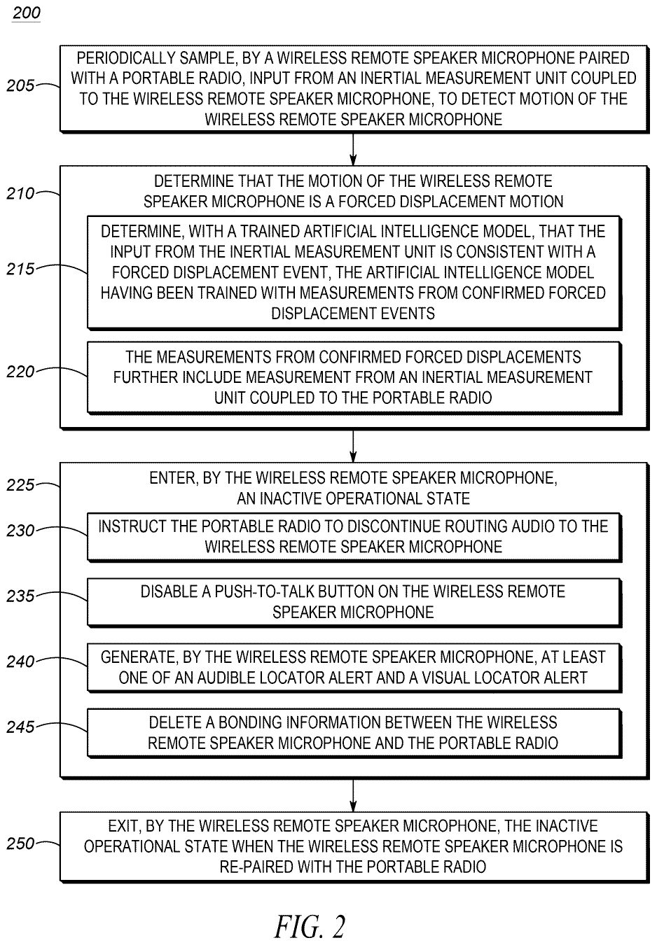

FIG. 2 depicts an example flow diagram 200 of an implementation of the techniques described herein. In block 205, a wireless remote speaker microphone paired with a portable radio periodically samples input from an inertial measurement unit coupled to the wireless remote speaker microphone to detect motion of the wireless remote speaker microphone. As described above the IMU is able to measure motion of the wireless RSM preferably using at least 6 degrees of freedom (e.g. linear acceleration in three dimensions and rotational acceleration in 3 dimensions) dimensions. The IMU may periodically make such measurements. Making the measurements may require the use of additional power and computational resources, thus increasing battery usage of the wireless RSM. The period of sampling can be set to achieve a good balance between quickly responding to motion conditions and reducing the amount of battery usage.

Additionally, the IMU may be configured to a low power state when the device detects a substantial lack of motion. In such a state, it is not sampling at the necessary rate and is not operating an inference engine needed to detect a forced displacement. It is, however operating in a manner to detect basic motion. If fact, some IMUs have this basic motion detection feature built-in to the IMU upon detecting some level of motion above a threshold, the IMU begins sampling motion at a rate sufficient to detect forced displacement and operate an inference engine to ingest the data. This approach will save battery power in situations where the officer is substantially sedentary for some amount of time. No action is required by the officer to transition between the low power and regular power states of the IMU and processing engine: it is fully automatic.

In block 210, it is determined that the motion of the wireless remote speaker microphone is a forced displacement motion. A forced displacement motion is when the wireless RSM indicates that the wireless RSM is no longer physically attached to the officer associated with that wireless RSM. In other words, the wireless RSM has become physically separated from the officer (e.g. fell on the ground, etc.). What should be understood is that it is determined that the forced displacement is actually a separation of the wireless RSM from the officer, as opposed to some other movement (e.g. the officer falling down with the wireless RSM still attached, the officer placing the wireless RSM in a charging dock, etc.). A forced displacement motion will only be determined when the wireless RSM is no longer physically connected to the officer.

In block 215, it is determined with a trained artificial intelligence model that the input from the inertial measurement unit is consistent with a forced displacement event. For example, the artificial intelligence model may be a machine learning model. The techniques described herein are not limited to any particular form of artificial intelligence models. The input from the inertial measurement unit is most commonly in the form of time series data. The artificial intelligence model has been trained with time series data from confirmed forced displacement events. As is known in the field of machine learning, a machine learning model may be trained by presenting data consistent with an event to be detected. This is often referred to as labeled data. The machine learning model may take this data and determine patterns in the data that may not be directly observable. Once trained, the model is able to receive data and determine if the received data is consistent with the event to be detected.

In the present example, the artificial intelligence model may be trained with IMU measurements from confirmed forced displacement events. The process of obtaining this training data set is described with respect to FIG. 3. Training the model involves presenting the IMU measurements, such as time series data, associated with confirmed forced displacement events to allow the model to identify patterns in the IMU measurement data that indicate a forced displacement. Once trained, the model can be presented with a time series of IMU measurement data and make a determination as to if the presented measurements are consistent with a forced displacement event.

In block 220, the measurements from confirmed forced displacements further include measurement from an inertial measurement unit coupled to the portable radio. As mentioned above, the portable radio may also include an IMU. The data from the IMU and the wireless RSM may be used to train the artificial intelligence model to determine when a forced displacement event has occurred. For example, if the wireless RSM is moving in one direction and the portable radio is moving in a different direction, this is a likely indicator that the two devices are no longer being carried by the officer. On the other hand, if the wireless RSM and portable radio both provide IMU data indicating both devices are moving together, this may indicate that both devices are still attached to the officer. Even if there is rapid movement, such as an officer falling, if the portable radio and wireless RSM are both falling together, it is unlikely this is a forced displacement event.

In block 225, the wireless remote speaker microphone enters an inactive operational state. As explained above, there are many undesirable things that may occur when a wireless RSM becomes separated from the officer to whom it is associated with. The inactive operational state alleviates concerns that come with the wireless RSM becoming separated from the officer.

In block 230, the portable radio is instructed to discontinue routing audio to the wireless remote speaker microphone. When the radio discontinues routing to the wireless RSM, it begins routing the audio to the speaker of the portable radio. This serves two purposes. First, because the officer is still in possession of the portable radio, he is able to hear any communications over the communications channel. Otherwise, the audio would have been played over the wireless RSM speaker, which the officer is no longer in possession of. Furthermore, by not routing audio to the speaker of the wireless RSM, someone who finds the wireless RSM will not be able to hear communications over the communications channel.

In block 235, the Push-to-Talk button on the wireless remote speaker microphone is also disabled. Disabling the PTT button on the wireless RSM prevents someone who finds the wireless RSM from disrupting the communications channel. As mentioned above, the communications channel is typically only available to one transmitter at a time. Should a bad actor find the wireless RSM and depress the PTT button, and either begin speaking or remaining silent, the communications channel will be occupied. If the communications channel is occupied, it is unable to be used by other first responders. Disabling the PTT button on the wireless RSM prevents this from occurring.

In block 240, the wireless remote speaker microphone generates at least one of an audible locator alert and a visual locator alert. The audible locator alert may be a sound emitted by the wireless RSM to aid in locating the wireless RSM. The audible alert may be a tone or voice announcement played via the wireless RSM speaker. The visual locator alert may be something like a LED lighting up to provide a visual indication as to where the wireless RSM is located. As mentioned above, in both cases, there may be a delay provided before either the audible or visual locator alert is enabled. In addition, if the wireless RSM is equipped with GPS, the present location can be recorded.

In block 245, a bonding information between the wireless remote speaker microphone and the portable radio is deleted. Deleting the bonding information between the two devices ensures that a re-bonding process must occur prior to allowing the wireless RSM to be connected to the portable radio.

In block 250, the wireless remote speaker microphone exits the inactive operational state when the wireless remote speaker microphone is re-paired with the portable radio. The re-pairing process may include first bonding the wireless RSM and the portable radio. It may include performing a touch pairing between the wireless RSM and the portable radio. It may include issuing a command on the portable radio to re-pair. Regardless of the particular technique used, the wireless RSM is then able to exit from the inactive operational state and resume normal operation (e.g. operation prior to the forced displacement event).

FIG. 3 depicts an example of sources of data that may be used to create a training data set, which can be used to train a machine learning model to detect a forced displacement. As mentioned above, a forced displacement occurs when the wireless RSM becomes physically separated from the officer associated with the wireless RSM. Because of the actions taken when the wireless RSM enters the inactive operational state due to a forced displacement, it is desirable that detection of a forced displacement be as accurate as possible. A false positive of a forced displacement could have somewhat severe consequences. For example, the PTT button on the wireless RSM is disabled, and the officer may wonder why the button no longer works. Or, when the audio is rerouted to the portable radio speaker, given the additional distance between the portable radio speaker and the officer's ear, depending on the volume level of the portable radio, the officer may not be able to hear incoming communications. Although in practice, there would be some type of indicator (e.g. LED, voice feedback, failed talk permit tone, etc.) that would alert the officer that the wireless RSM is in an inactive operational state, this is just more information adding to the officer's cognitive load. It would be preferable to minimize the number of false positives.

Given the actions taken when a forced displacement occurs, it is desirable to ensure other events, are not confused with a forced displacement. For example, an officer roughly inserting the wireless RSM into a charging dock should not be considered a forced displacement, even if the IMU measurements may be similar. Likewise, an officer dropping the wireless RSM onto a table (e.g. an event that could appear to be a free fall, etc.) should not be considered a forced displacement. What should be understood is that drop detection alone is not sufficient to indicate a forced displacement event.

In one example implementation of an algorithm to detect forced displacements, the IMU measurements may be analyzed to determine thresholds to indicate a forced displacement event. IMU measurements from the wireless RSM as well as IMU measurements from the portable radio could be analyzed to determine thresholds for both the wireless RSM and portable radio that will indicate that a forced displacement has occurred. For example, the IMU measurements for when an officer dons/doffs the RSM could be collected. IMU measurements for normal use of the wireless RSM could be collected. IMU measurements for insertion or removal into a charging station could be collected. IMU measurements of accidental drops could be collected. Based on this data, thresholds could be established to determine when a forced displacement event has occurred.

The IMU measurements may be taken from both the wireless RSM and the portable radio. When setting the thresholds, the measurements from both the wireless RSM and the portable radio need to be taken into account. For example, a wireless RSM that indicates it is in free-fall while the radio indicates it is stationary may be an indication that, depending on the velocity of the wireless RSM, that the wireless RSM is being dropped on a desk. However, the same situation where the wireless RSM is experiencing motion faster than free fall may indicate the wireless RSM is being tossed away form the portable radio. Likewise, a situation where both the wireless RSM and portable radio are shown as being in free fall, this may indicate that the officer is falling down, but both the portable radio and wireless RSM are still attached to the officer. As should be clear, manual provisioning of IMU measurement thresholds to detect forced displacement events can be quite complex, given the large numbers of variables.

An alternative solution to manually configuring forced displacement detection using thresholds is to use a trained artificial intelligence model. As is well known in the field of artificial intelligence models, a model can be trained with a data set, referred to as training data, which exhibit the behavior that is desired to be detected. The training process causes the model to learn patterns in the data that might not be detectable by the human mind. Once the model is trained, arbitrary data can be input into the trained model, and a determination is made if the arbitrary data represents the behavior that is desired to be detected.

In the present example, the artificial intelligence model may be trained using data that represents confirmed forced displacement events. The input data may include data from the IMU on the wireless RSM, which can explain how the wireless RSM is moving. The data can also include data from the IMU on the portable radio to determine how the portable radio is moving. The training data may be labeled to indicate if the data represents a forced displacement event or if it does not represent a forced displacement event. Although the remainder of the discussion will be described in terms of training data that is labeled to indicate a forced displacement event has occurred, it should be understood that the same techniques are used to capture training data that is labeled as non-forced displacement. In other words, the training data includes situations where the forced displacement occurs as well as situations where there is no forced displacement. During training of the artificial intelligence model, each data tuple (e.g. IMU measurements, etc.) is presented to the model and the model makes a prediction based on the current training of the model as to if the data tuple represents a forced displacement event.

The prediction of the model is then compared to the labeled data to determine if the prediction was correct. If the prediction was correct, the internal weightings of the model may be reinforced, based on the correct prediction. If the prediction is incorrect, the model weightings may be modified to reflect the incorrect prediction. After going through this process with hundreds or thousands of tuples the model may be considered trained. Training may be considered complete when the model is presented with arbitrary labeled data, and is able to correctly predict a forced displacement with a desired level of accuracy (e.g. 95%, etc.). As should be clear, the more labeled training data available, the better the training of the model.

FIG. 3 depicts a training data 310 database that may be used to hold the labeled data that is used to train the artificial intelligence model. This labeled training data may include IMU measurement data from a wireless RSM, IMU measurement data from the portable radio, as well as a label indicating if the tuple was or was not an actual forced displacement event.

Once source of training data may be simulated data 320. Simulated data may be generated by attaching a wireless RSM and portable radio to an officer and then simulating forced displacement events. For example, the officer could grab the wireless RSM and throw it across the room. This event could be labeled as a forced displacement event. As yet another example, the officer may roughly discard the wireless RSM onto a table or into a charging dock. Such events would be labeled as not being a forced displacement event.

Another source of training data may be synthetic data 330. Modeling engines have gotten quite good at modeling the physics associated with movement of people and objects. A modeling engine could be configured to represent a person as well as a wireless RSM and portable radio. Synthetic situations of forced displacement of the wireless RSM could be created. The modeling engine would be able to simulate the expected IMU measurements from such forced displacement scenarios and label the data tuples accordingly.

Yet another source of training data may be field data plus reports 340. The wireless RSM and portable radio may include the ability to store the IMU measurement data. This stored measurement data may then be correlated with reports that an officer writes. For example, when writing the report for an incident, the officer may state that the suspect grabbed his RSM and threw it across the road. Such an event would be a confirmed forced displacement event. The IMU measurements corresponding to the period of the report could be retrieved and stored as a tuple labeled as a forced displacement event.

As yet another example, field data plus external sources 350 could be used as a source of training data. In today's world, the presence of surveillance cameras has become ubiquitous. When a surveillance camera is able to detect that a forced displacement has occurred (e.g. the camera detects the wireless RSM leaving the officer's body, etc.) the stored data from the IMU measurements can be retrieved and labeled as a forced displacement event.

Although several examples of sources of training data have been presented, it should be understood that the techniques described herein are not dependent on any particular technique acquiring training data. What should be understood is that the training data consists of tuples of data that include IMU measurement data as well as a label to indicate if the tuple represents or does not represent a forced displacement event. This training data is then used to train the artificial intelligence model 360. The trained artificial intelligence model includes the weights established during model training as well as the execution environment to infer when a forced displacement has occurred based on the IMU input data.

The trained artificial intelligence model may then be deployed onto the wireless RSM. The trained model receives IMU data from the wireless RSM, and potentially from the portable radio as well, periodically. This data is input into the trained artificial intelligence model, which, based on the training, provides a prediction as to if the wireless RSM has experienced a forced displacement. If so, the inactive operational state procedures described above are initiated.

FIG. 4 is an example of a hardware device 400 that may implement a wireless RSM or a portable radio. The communication device 400 may be, for example, embodied in the wireless RSM 114 and/or portable radio 118 and/or may be a distributed communication device across two or more of the foregoing (or multiple of a same type of one of the foregoing) and linked via a wired and/or wireless communication link(s). In some embodiments, the communication device 400 acting as a wireless RSM may be communicatively coupled to other devices such as a communication device 400 acting as a portable radio.

While FIG. 4 represents the communication devices described above with respect to FIG. 1, depending on the type of the communication device, the communication device 400 may include fewer or additional components in configurations different from that illustrated in FIG. 4. For example, in some embodiments, communication device 400 acting as the wireless RSM 114 may not include one or more of the screen 405, input device 406, and imaging device 421. As another example, in some embodiments, the communication device 400 acting as the portable radio 118 may further include a location determination device (for example, a global positioning system (GPS) receiver). Other combinations are possible as well.

As shown in FIG. 4, communication device 400 includes a communications unit 402 coupled to a common data and address bus 417 of a processing unit 403. The communication device 400 may also include one or more input devices (e.g., keypad, pointing device, touch-sensitive surface, etc.) 406 and an electronic display screen 405 (which, in some embodiments, may be a touch screen and thus also act as an input device 406), each coupled to be in communication with the processing unit 403. The input devices may also include a PTT button that allows for communication to be initiated.

Communication device 400 includes IMU 430. The IMU, as described above, allows for the communication device to determine how it is moving. As explained above, these measurements are used to determine when a forced displacement event has occurred. The communication device also includes LED lights 435. The LED lights are used as a visual indicator to help find a wireless RSM that has experienced a forced displacement.

The microphone 420 may be present for capturing audio from a user and/or other environmental or background audio that is further processed by processing unit 403 in accordance with the remainder of this disclosure and/or is transmitted as voice or audio stream data, or as acoustical environment indications, by communications unit 402 to other portable radios and/or other communication devices. The imaging device 421 may provide video (still or moving images) of an area in a field of view of the communication device 400 for further processing by the processing unit 403 and/or for further transmission by the communications unit 402. A speaker 422 may be present for reproducing audio that is decoded from voice or audio streams of calls received via the communications unit 402 from other portable radios, from digital audio stored at the communication device 400, from other ad-hoc or direct mode devices, and/or from an infrastructure RAN device, or may playback alert tones or other types of pre-recorded audio.

The processing unit 403 may include a code Read Only Memory (ROM) 412 coupled to the common data and address bus 417 for storing data for initializing system components. The processing unit 403 may further include an electronic processor 413 (for example, a microprocessor or another electronic device) coupled, by the common data and address bus 417, to a Random Access Memory (RAM) 404 and a static memory 416.

The communications unit 402 may include one or more wired and/or wireless input/output (I/O) interfaces 409 that are configurable to communicate with other communication devices. For example, the interfaces 409 may include the wireless interfaces that are used for wireless communication between the wireless RSM 114 and the portable radio 118.

For example, the communications unit 402 may include one or more wireless transceivers 408, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 402 may additionally or alternatively include one or more wireline transceivers 408, such as an Ethernet transceiver, a USB transceiver, or similar transceiver configurable to communicate via a twisted pair wire, a coaxial cable, a fiber-optic link, or a similar physical connection to a wireline network. The transceiver 408 is also coupled to a combined modulator/demodulator 410.

The electronic processor 413 has ports for coupling to the display screen 405, the input device 406, the microphone 420, the imaging device 421, and/or the speaker 422. Static memory 416 may store operating code 425 for the electronic processor 413 that, when executed, performs one or more of the steps set forth in FIG. 2 and accompanying text. Furthermore, the static memory 416 may store code that when executed causes the processor to implement the trained artificial intelligence model 360 described with respect to FIG. 3.

The static memory 416 may comprise, for example, a hard-disk drive (HDD), an optical disk drive such as a compact disk (CD) drive or digital versatile disk (DVD) drive, a solid state drive (SSD), a flash memory drive, or a tape drive, and the like.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot monitor input from an inertial management unit, implement a trained artificial intelligence model, or enter an inactive operational state, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
periodically sampling, by a wireless remote speaker microphone paired with a portable radio, input from an inertial measurement unit coupled to the wireless remote speaker microphone, to detect motion of the wireless remote speaker microphone;
determining that the motion of the wireless remote speaker microphone is a forced displacement motion; and
entering, by the wireless remote speaker microphone, an inactive operational state.

2. The method of claim 1, wherein entering the inactive operational state further comprises:
instructing the portable radio to discontinue routing audio to the wireless remote speaker microphone; and
disabling a Push-to-Talk button on the wireless remote speaker microphone.

3. The method of claim 1 wherein entering the inactive operational state further comprises:
generating, by the wireless remote speaker microphone, at least one of an audible locator alert and a visual locator alert.

4. The method of claim 1 further comprising:
exiting, by the wireless remote speaker microphone, the inactive operational state when the wireless remote speaker microphone is re-paired with the portable radio.

5. The method of claim 1 wherein determining that the motion of the wireless remote speaker microphone is a forced displacement motion further comprises:
determining, with a trained Artificial Intelligence model, that the input from the inertial measurement unit is consistent with a forced displacement event, the Artificial Intelligence model having been trained with measurements from confirmed forced displacement events.

6. The method of claim 5 wherein the measurements from confirmed forced displacements further include measurement from an inertial measurement unit coupled to the portable radio.

7. The method of claim 1 wherein entering, by the wireless remote speaker microphone, the inactive operational state further comprises:
deleting a bonding information between the wireless remote speaker microphone and the portable radio.

8. A system comprising:
a processor; and
a memory coupled to the processor, the memory containing a set of instructions thereon that when executed by the processor cause the processor to:
periodically sample, by a wireless remote speaker microphone paired with a portable radio, input from an inertial measurement unit coupled to the wireless remote speaker microphone, to detect motion of the wireless remote speaker microphone;
determine that the motion of the wireless remote speaker microphone is a forced displacement motion; and
enter, by the wireless remote speaker microphone, an inactive operational state.

9. The system of claim 8, wherein entering the inactive operational state further comprises instructions on the memory to:
instruct the portable radio to discontinue routing audio to the wireless remote speaker microphone; and
disable a Push-to-Talk button on the wireless remote speaker microphone.

10. The system of claim 8 wherein entering the inactive operational state further comprises instructions on the memory to:
generate, by the wireless remote speaker microphone, at least one of an audible locator alert and a visual locator alert.

11. The system of claim 8 further comprising instructions on the memory to:
exit, by the wireless remote speaker microphone, the inactive operational state when the wireless remote speaker microphone is re-paired with the portable radio.

12. The system of claim 8 wherein determining that the motion of the wireless remote speaker microphone is a forced displacement motion further comprises instructions on the memory to:
determine, with a trained Artificial Intelligence model, that the input from the inertial measurement unit is consistent with a forced displacement event, the Artificial Intelligence model having been trained with measurements from confirmed forced displacement events.

13. The system of claim 12 wherein the measurements from confirmed forced displacements further include measurement from an inertial measurement unit coupled to the portable radio.

14. The system of claim 8 wherein entering, by the wireless remote speaker microphone, the inactive operational state further comprises instructions on the memory to:
delete a bonding information between the wireless remote speaker microphone and the portable radio.

15. A non-transitory processor readable medium containing a set of instructions thereon that when executed by a processor cause the processor to:
periodically sample, by a wireless remote speaker microphone paired with a portable radio, input from an inertial measurement unit coupled to the wireless remote speaker microphone, to detect motion of the wireless remote speaker microphone;
determine that the motion of the wireless remote speaker microphone is a forced displacement motion; and
enter, by the wireless remote speaker microphone, an inactive operational state.

16. The medium of claim 15, wherein entering the inactive operational state further comprises instructions on the medium to:
instruct the portable radio to discontinue routing audio to the wireless remote speaker microphone; and
disable a Push-to-Talk button on the wireless remote speaker microphone.

17. The medium of claim 15 wherein entering the inactive operational state further comprises instructions on the medium to:
generate, by the wireless remote speaker microphone, at least one of an audible locator alert and a visual locator alert.

18. The medium of claim 15 further comprising instructions on the medium to:
exit, by the wireless remote speaker microphone, the inactive operational state when the wireless remote speaker microphone is re-paired with the portable radio.

19. The medium of claim 15 wherein determining that the motion of the wireless remote speaker microphone is a forced displacement motion further comprises instructions on the medium to:
determine, with a trained Artificial Intelligence model, that the input from the inertial measurement unit is consistent with a forced displacement event, the Artificial Intelligence model having been trained with measurements from confirmed forced displacement events.

20. The medium of claim 15 wherein entering, by the wireless remote speaker microphone, the inactive operational state further comprises instructions on the medium to:
delete a bonding information between the wireless remote speaker microphone and the portable radio.
